(19) United States
(12) Patent Application Publication
(10) Pub. No.: US 2002/0157227 A1
(43) Pub. Date: Oct. 31, 2002

(54) Drill template with key registration for safety deposit box

(76) Inventor: Michael R. Hedrick, Chillicothe, OH (US)

Correspondence Address: John H. Faro, Esq., Faro & Associates, P.O. Box 4904, Key Biscayne, FL, 33149-4904, US

(21) Appl. No.: 09/843,438

(22) Filed: Apr. 26, 2001

(51) Int. Cl. B23P 19/04

(52) U.S. Cl. 29/259

(57) ABSTRACT

A template for the precision drilling of an access hole in a the door of a safety deposit box is disclosed. The access hole in the box door permits a locksmith to pick the dual cylinder lock for which the key has been lost. In one of the preferred embodiments of this invention, the template includes a planar component or element comprises an inflexible, rectangular plate (e.g. metal or structural plastic), generally smaller than the dimension of the safety deposit box door. This plate includes at least one and preferable multiple registration means for alignment of a drill bit guide in relation to the box locking mechanism that is mounted on the interior surface of the safety deposit box door.

### BACKGROUND OF THE INVENTION

1. Field of the Invention

This invention relates to a device and to method. More specifically, this invention relates to template for drilling a face plate of lock box (e.g. safety deposit box) so as to gain access to the locking mechanism therein and to permit a locksmith to pick the lock and, thus, open the lock without damage or defacement.

2. Description of the Prior Art

Multiple key locks of the type used in safety deposit boxes require two different keys to unlock the box. Generally, one key is retained within the bank, in which the safety deposit box is located, and the other key retained in the possession of the box renter. Where the box renter loses or misplaces the key, or, as often occurs, is deceased and the whereabouts of the second key unknown, access to the contents of the safety deposit box is denied. Under such circumstances, the box can only be opened by punching out the key cylinder (which results in its destruction and requires its subsequent); or, by drilling through the face plate of the safety deposit box in an effort to gain access to the locking mechanism to allow the locksmith to pick the lock. In the former instance, the destruction of the key cylinder, particularly in older safety deposit boxes, is generally unacceptable because of the lack of availability of a replacement. With respect to the less destructive alternative, specifically drilling through the face plate of the box, such task cannot generally be performed with precision and, thus, the face plate of the box is defaced, or alternatively, multiple holes must be drilled to expose the locking mechanism within the box to the locksmith's pick.

The inadequacies in each of these alternatives have been generally recognized and alternative locking mechanism proposed to avoid this very problem. The following patents are representative of such alternative locking systems for safety deposit boxes.

U.S. Pat. No. 5,979,198 (to Haas-Trober, et al., issued Nov. 9, 1999) The Haas-Trober, et al invention provides a locking mechanism equipped with an emergency opening function that can easily be triggered at any time, but delays the release of the locking mechanism until after a predetermined waiting period selected by the authorized user. The locking mechanism has application to safety deposit boxes; and, is intended to eliminate the problem of opening the box when the renter has lost his key. A choice of the appropriate time delay ensures that an unauthorized person, even when having knowledge about the emergency opening function, is prevented from accessing the safe or vault because the unauthorized person has no knowledge about the duration of the waiting period. In that respect, the locking mechanism differs from so-called time locks used in high security containers such as e.g. vaults of banks.

U.S. Pat. No. 5,475,376 (to Chikamitue, et al., issued Dec. 12, 1995) The Chikamitue, et al., invention, provides a safety-deposit box system in which a multi-function key is used. The multi-function key includes a first electronic memory portion and a metal key portion. The first electronic memory portion has recorded therein a first set of safety-deposit box user information. The system controller associated with this system outputs a permission-to-use signal when the first set of safety-deposit box user information the multi-function key agrees with the second set of safety-deposit box user information stored in the system. There is further provided a safety-deposit box controller including a mechanical appropriateness determination means for determining mechanical appropriateness of the metal key portion. The safety-deposit box controller receives the permission-to-use signal and opens the user-side lock if the mechanical appropriateness determination means determines that the metal key portion is mechanically appropriate.

While such alternatives may be acceptable for a bank contemplating a new safety deposit box installation, they do not provide an acceptable solution to the problems encountered within the existing population of safety deposit boxes (which number in the tens of thousands). More specifically, the expense incident to the replacement of the existing the double key lock mechanism of the more traditional safety deposit boxes is considerable, and, thus, the banks and depositories have and continue to retain the traditional style of box so long as such boxes remain serviceable. The ability to maintain such traditional style safety deposit boxes in service requires that reliable means be developed to unlock such boxes where the renter's key is lost. The current systems for drilling through the face plate of the box is unacceptable due to imprecision inherent in such effort and the often irremediable consequences resulting therefrom. Accordingly, there continues to exist a need to develop a system and method for opening a locked safety deposit box without irremediable damage to either the locking mechanism or to the face plate of the box.

### OBJECTS OF THE INVENTION

It is the object of this invention to remedy the above as well as related deficiencies in the prior art.

More specifically, it is the principle object of this invention to provide a means for gaining access to the contents of a safety deposit box without irremediable damage to the safety deposit box.

It is another object of this invention to provide a template for precision drilling of the face plate of a safety deposit box to gain access to the locking mechanism thereof.

Additional objects of this invention include a kit for gaining access to the contents of a locked safety deposit box wherein the renter's key has been lost or is otherwise unavailable.

### BRIEF DESCRIPTION OF THE DRAWINGS

FIG. 1 is a perspective view of template for precision drilling of a dual key lock installed on the face plate of a safety deposit box.

FIG. 2 is an end-on view of the template of FIG. 1 when viewed from above.

FIG. 3 is a partial section through a safety deposit box access door wherein said access is in the locked position and a dual cylinder lock is maintaining said access door in the locked position.

FIG. 4 is a partial section through the safety deposit box access door of FIG. 3 in combination with the template of FIG. 2.

FIG. 5 is a perspective view of the lock picks that can be used to release the locking mechanism of the safety deposit box door.

### SUMMARY OF THE INVENTION

The above and related objects are achieved by providing a template for the precision drilling of an access hole in the door of a safety deposit box so as to permit a locksmith to pick a cylinder lock for which the key has been lost. In one of the preferred embodiments of this invention, the template includes a planar component or element comprising an inflexible, rectangular plate (e.g. metal or structural plastic), generally smaller in area than the dimension of the safety deposit box door. This plate includes at least one, and preferable multiple, registration means for alignment of a drill bit guide in relation to the box locking mechanism that is mounted on the interior surface of the safety deposit box door.

The registration means associated with the template of this invention includes one or more key blank-like extensions that are affixed to the top-side of the planar element for insertion into the key way of the cylinder locks of the safety deposit box. Each of these key blanks of the template engage the dual cylinder locks of the safety deposit box so as to position the a drill bit guide on the template relative to the locking mechanism mounted within the box. The drill bit guide, thus, aligns the drill bit relative to the box so as to permit the drilling of an access hole through the safety deposit box door, and into the locking mechanism.

Upon drilling of the access hole, the template is removed. The bank's key is inserted into the “guard side” of the lock, and this cylinder lock disengaged. A lock pick is now inserted by a locksmith in the renter's key cylinder (20), and a piece of wire through the access hole (in the door of the safety deposit box) into locking mechanism within the safety deposit box. The locksmith then manipulates the levers within the key cylinder with a lock pick to align the locked key cylinder levers with a piece of wire that has been inserted through the access hole into the locking mechanism. Upon alignment of all of the cylinder levers of the renter's key cylinder, the renter's key cylinder is unlocked, and the bolt of the locking mechanism retracted. The safety deposit box can now be opened. Once opened, the locking mechanism can be removed and the key cylinders re-keyed, or replaced, as appropriate.

### DETAILED DESCRIPTION OF THE INVENTION INCLUDING PREFERRED EMBODIMENTS

The device and kit of this invention are described hereinafter by reference to the accompanying figures. In order to provide continuity of expression and ease of understanding, the elements in common to each of these figures have been assigned the same reference numeral.

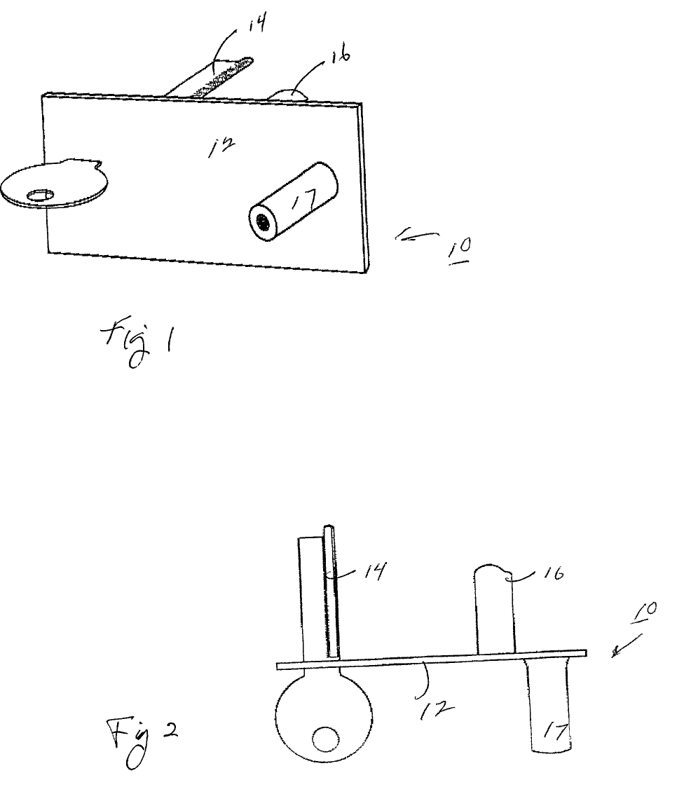

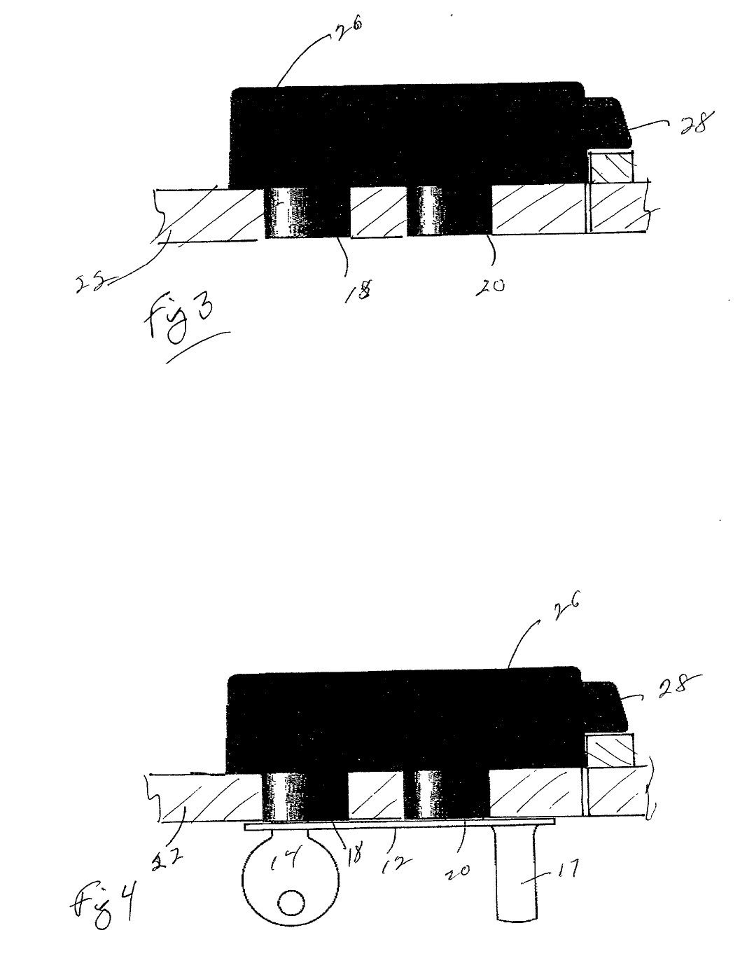

FIGS. 1 & 2 depict a representative embodiment of the template (10) of this invention. As shown in each of these illustrations, the template (10) comprises

(a) a planar element or plate (12) of inflexible material (e.g. metal or structural plastic);

(b) a series of key cylinder registration elements (14, 16) corresponding to the keyways (not shown) of the lock for which the template (10) has been designed; and,

(c) a drill bit positioning guide (17).

In practice, each of the key cylinder registration elements (14, 16) associated with the template (10) can be integral with the planar element of the template or, alternatively, removable to permit interchangeability thereof with other key registration elements of different designs (e.g. profile and length). As shown in these Figures, each of the key cylinder registration elements (14, 16) project from the surface planar element (12) that is to be disposed toward each of the cylinder locks (18, 20) that are installed on the safety deposit box door (22). A drill bit guide (17) is mounted on the opposite surface of the planar element. The relative location/positioning of the key cylinder registration elements (14, 16) and drill bit guide (17) are calculated to insure the proper alignment of a drill bit relative to the surface of safety deposit box door, of the type illustrated in FIG. 3.

FIG. 3 illustrates a dual cylinder lock (18, 20) installed in a safety deposit box door (22). The locking mechanism (26) is shown in a locked position, that is with an extended bolt (28) engaging a striker bar or latch (30) on the inside of the safety deposit box. For the purposes of this invention, it is assumed that the key for the cylinder lock on the right (20) shown in the illustration is unavailable and, thus, the safety deposit box cannot be opened. In order to gain access to the locking mechanism (26) housing within the box, a hole must be drill through the safety deposit box door (22) between the lock (20) on the right and the edge of the door, specifically, between the cylinder (20) of the lock on to the right and the extended bolt (28) of the locking mechanism.

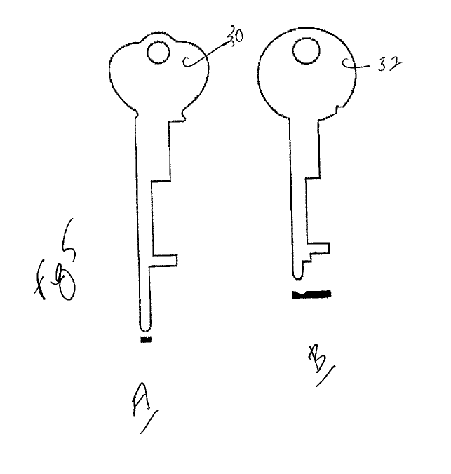

The template (10) of this invention, provides the means for accomplishing the precision drilling of an access hole through the door (22) of the safety deposit box and into the locking mechanism (26). This is accomplished by simply insertion of the key registration elements (14, 16) of the template into each of the key cylinders (18, 20) of the dual cylinder locks, as illustrated in FIG. 4. Once the template (10) of this invention is installed into the dual cylinder locks (18, 20) of the safety deposit box door (22), the locksmith inserts a drill bit through the drill bit guide (17) and drills through the surface of the safety deposit box door (22) into the locking mechanism (26) proximate to the key cylinder (20) on closest to the extended bolt (28) of the locking mechanism (26). Once such access hole has been drilled the template (10) is removed and the renter's cylinder lock (20) picked with one of the lock picks (30, 32) illustrated in FIG. 5. More specifically, the bank's key can now be inserted into the “guard side” of the lock, and this cylinder lock (18) disengaged. A lock pick (30) is now inserted by a locksmith into the key cylinder (20), and it is used to lift each of the cylinder levers in the renter's side of the safety deposit box. As each lever is lift, a music wire is inserted through the access hole into the locking mechanism (28). The music wire holds each cylinder lever in-line with within the locking mechanism. When all of the levers are in in-line, the renter's side of the safety deposit box can now be unlocked and the boxed opened.

The preferred lock picks of the kit of this invention are illustrated in FIG. 5. Each of these picks are unique to this kit by virtue of the extension (34, 36) present on the distal end thereof More specifically, the extension of the pick is designed to engage key cylinder (20), so as to stabilize the pick within the key cylinder (20), and thereby permit precision placement thereof and, thus, rapid alignment thereof and the opening of the locking mechanism. Once opened, the locking mechanism can be removed and the key cylinders re-keyed, or replaced, as appropriate.

The template, thus, facilitates the drilling of an access hole in the safety deposit box door without substantial damage to either the key way or lock cylinders of the door itself. Subsequent to drilling and opening of the door, the locking mechanism (26) can be removed and the key way/cylinder for which no key is available, either re-keyed or replaced. Thereafter, the locking mechanism with the new or re-keyed cylinder reinstalled and the hole in the safety deposit box door plugged. The plug is then ground to a finish which is hardly distinguishable from the surface of the safety deposit box door.

What is claimed is:

1. A template for precision drilling of an access hole in a safety deposit box door without damage or destruction to the dual cylinder locking mechanism, so as to permit access to said locking mechanism and picking of one of said cylinder locks on the safety deposit box door, said template comprising:
A. A planar element of a structural material having a top-side and an underside;
B. Template registration means extending from said top-side surface of said planar element, each of said registration means comprising an elongate member corresponding to a keyway of a key cylinder of said locking mechanism of said safety deposit box,
C. A drill bit guide extending from said under-side surface of said planar, said guide including a tubular member having an elongate barrel in alignment with a hole in said planar element so as to provide a continuous guide and precision placement of drill bit relative to said locking mechanism of said of said safety deposit box.

2. The template of claim 1, wherein at least one of said template registration means is integral with said top-side of said planar element.

3. The template of claim 1, wherein each of said template registration means are integral with said top-side of said planar element.

4. The template of claim 1, wherein one end of said drill bit guide is mounted within a hole in said planar element.

5. The template of claim 1, wherein one end of said drill bit guide is designed to both provide positioning of a drill bit relative to said safety deposit box lock and to control the depth of penetration of said drill bit through said safety deposit box door and into said locking mechanism associated with said door.

6. A kit for opening a safety deposit box having a locking mechanism with dual key cylinders, said kit comprising:
A. A template for precision drilling of an access hole in a safety deposit box door without damage or destruction to the dual cylinder locking mechanism, so as to permit access to said locking mechanism and picking of one of said cylinder locks on the safety deposit box door, said template having:
(1). A planar element of a structural material having a top-side and an under-side;
(2). Template registration means extending from said top-side surface of said planar element, each of said registration means comprising an elongate member corresponding to a keyway of a key cylinder of said locking mechanism of said safety deposit box,
(3). A drill bit guide extending from said under-side surface of said planar, said guide including a tubular member having an elongate barrel in alignment with a hole in said planar element so as to provide a continuous guide and precision placement of drill bit relative to said locking mechanism of said of said safety deposit box; and
B. A lock pick specific for picking one of said key cylinders of said dual locking mechanism of said safety deposit box.
